(19) United States
(12) Patent Application Publication
(10) Pub. No.: US 2006/0170754 A1
(43) Pub. Date: Aug. 3, 2006

(54) Image forming apparatus that detects color registration deviation and positional deviation detecting method

(76) Inventor: Katsuyuki Kitao, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/328,279

(22) Filed: Jan. 10, 2006

(30) Foreign Application Priority Data
Jan. 13, 2005 (JP) 2005-006099

(51) Int. Cl. B41J 2/385; G03G 15/01

(52) U.S. Cl. 347/116

(57) ABSTRACT

An image forming apparatus includes a light receiving unit that irradiates light and receives a light reflected from patterns on a transfer member. The patterns include an upper layer as a reference color with low lightness overlapping a lower layer serving as a non-reference color with high lightness. At least the lower layer is halftone. A deviation amount detector in the image forming apparatus detects a deviation amount of the lower layer relative to the upper layer according to density information of the patterns based on the light received by the light receiving unit.

### CROSS-REFERENCE TO RELATED APPLICATIONS

The present document incorporates by reference the entire contents of Japanese priority document, 2005-006099 filed in Japan on Jan. 13, 2005.

### BACKGROUND OF THE INVENTION

1. Field of the Invention

The present invention relates to an image forming apparatus that can detect color registration deviation in image formation and a positional deviation detecting method.

2. Description of the Related Art

Color image forming apparatuses for forming color images using four colors of magenta (M), cyan (C), yellow (Y), and black (B) have been known. In such color image forming apparatuses, color registration deviation among output images of respective colors of magenta, cyan, yellow, and black must be eliminated to improve image quality. In a quadruple tandem system, a writing optical system and an image carrier is provided for each color, and an image of each color is formed on different image carriers. Accordingly, color registration deviation is particularly apt to occur.

One approach for correcting the color registration deviation is to write patterns for detecting positional deviation on a transfer belt or the like, and read the patterns using a sensor to detect deviation amounts among respective color images, thereby adjusting writing timings or correcting the positional deviation at an optical system corrector to correct the positional deviation.

For example, Japanese Patent Application Laid-open No. 2002-91119 discloses a tandem type image forming apparatus for performing positional deviation adjustment or density adjustment with high precision, where a plurality of reference color test print patterns that have image forming blank areas and are formed as images using reference print colors for the image forming apparatus and the image forming blank areas of the reference color test print patterns are made to correspond to each other to adjust an image forming position in various ratios so as to fill the image forming blank areas, an image formed on a transfer belt is made to overlap on the reference color test print patterns, and a density of the overlapping image is detected so that positional deviation of a color image is detected.

Japanese Patent Application Laid-open No. 2002-40746 discloses an image forming apparatus that uses a small number of patches to correct density change between a production start side of the patches and a production end side thereof in a color image forming apparatus of a tandem type or the like, where a constitution for adjusting printing positions in respective image forming units is adopted, a patch at a registration position where a density becomes maximum and a patch at a registration deviation position where a density becomes minimum are produced, and a registration deviation amount is calculated from actual density values of the patches detected to perform registration correction.

In an image forming apparatus disclosed in Japanese Patent Application Laid-open No. 2003-43772, reference patterns for measurement where a reflecting density changes according to positional deviation among respective colors on a recording sheet is formed, and correction values for respective image forming units are obtained while the reference patterns for measurement are measured by a reflection density sensor, so that the respective image forming units are controlled.

In another image forming apparatus disclosed in Japanese Patent Application Laid-open No. 2003-280315, a reference voltage stored in a nonvolatile memory and an detection output of a positional deviation detection mark are compared with each other, and when a difference is equal to or more than a predetermined value in the comparison, a reference value of the reference voltage is newly set and the newly set value is stored in the nonvolatile memory for each new setting. Accordingly, even when density fluctuation occurs, a mark detecting process can be achieved by a single mark production process.

These inventions can employ a method of preparing patterns for detecting a positional deviation amount in a main scanning direction shown in FIG. 9, and arranging the patterns in a sensor reading direction to obtain a positional deviation amount from outputs of respective detected patterns. However, when patterns are arranged and a positional deviation amount is measured by this method, a sensor output fluctuates by fluctuation of an image density, which decreases precision of a detected deviation amount.

### SUMMARY OF THE INVENTION

It is an object of the present invention to at least solve the problems in the conventional technology.

According to an aspect of the present invention, an image forming apparatus includes a light receiving unit that irradiates light to patterns including a plurality of colors formed on an image carrier and then transferred onto a transfer member, and receives a light reflected from the patterns, the patterns including an upper layer serving as a reference color with low lightness overlapping a lower layer serving as a non-reference color with high lightness, wherein at least the lower layer is halftone, and a deviation amount detector that detects a deviation amount of the lower layer relative to the upper layer as a writing positional deviation amount according to density information of the patterns based on the light received by the light receiving unit.

According to another aspect of the present invention, a method of forming an image in an image forming apparatus including an image carrier and a transfer member includes irradiating light to patterns including a plurality of colors formed on the image carrier and then transferred onto the transfer member, the patterns including an upper layer serving as a reference color with low lightness overlapping a lower layer serving as a non-reference color with high lightness, wherein at least the lower layer is halftone, receiving a light reflected from the patterns, and detecting a deviation amount of the lower layer relative to the upper layer as a writing positional deviation amount according to density information of the patterns based on the light received at the receiving.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts positional deviation detection with a detection pattern;

FIG. 2 depicts positional deviation detection with another detection pattern;

FIG. 3 depicts positional deviation detection with still another detection pattern;

FIG. 4 depicts positional deviation detection with still another detection pattern;

FIG. 5 depicts positional deviation detection with still another detection pattern;

FIG. 6 is an example of a positional deviation detecting method according to an embodiment of the present invention;

FIG. 7 is one example of an image forming apparatus according to the embodiment;

FIG. 8 is an example of a position detector in the image forming apparatus according to the embodiment; and

FIG. 9 depicts positional deviation detection according to conventional patterns, in which a portion where a pattern formed leftward downwardly in a zigzag manner and a linear pattern overlap each other is where positional deviation is detected.

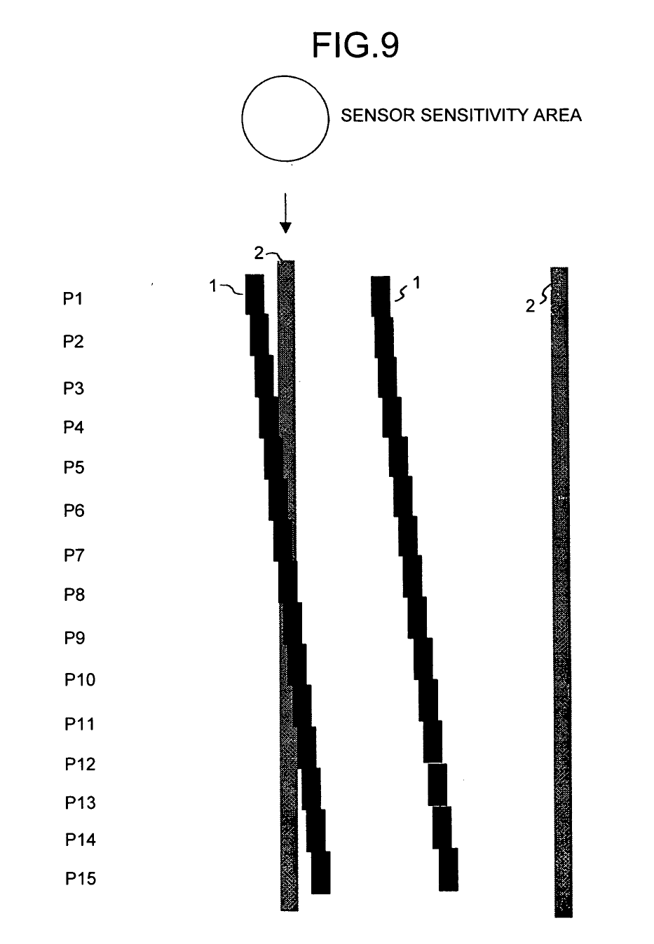

### DETAILED DESCRIPTION OF THE PREFERRED EMBODIMENTS

Exemplary embodiments of the present invention will be described below with reference to accompanying drawings. The present invention is not limited to these embodiments.

An image forming apparatus and a positional deviation detecting method according to the present invention are explained below.

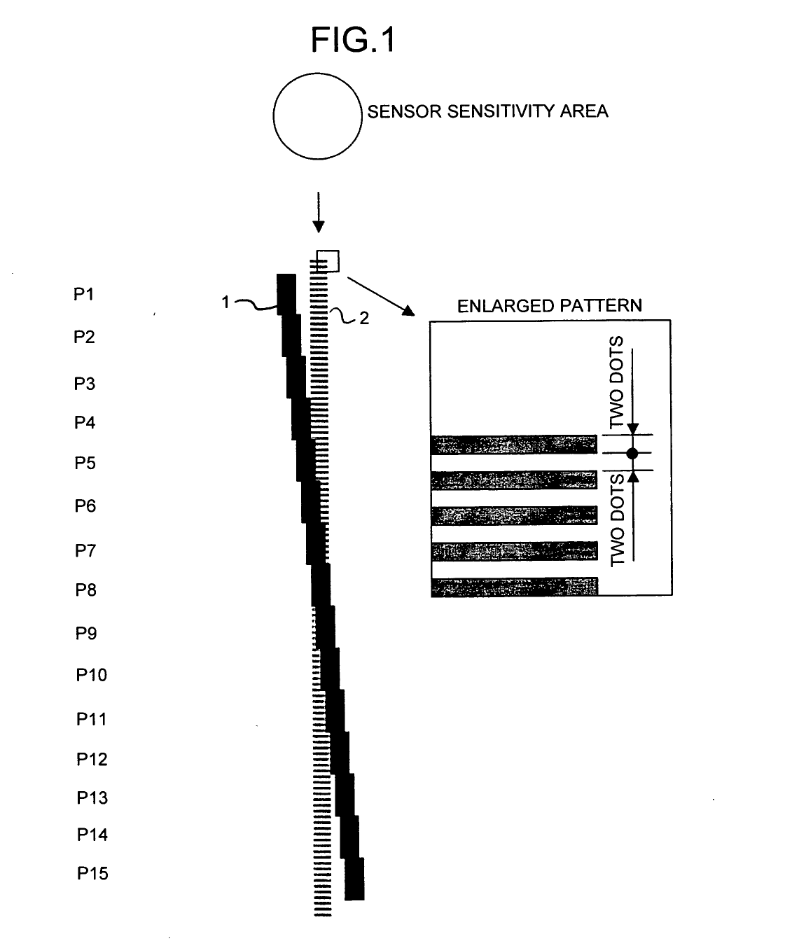

FIG. 1 depicts a lower pattern of two overlapping color patterns formed by a halftone 2. Each of the halftones 2 used can be formed by arranging lines with two dot width at intervals of two dots, for example. A width of a line for forming the halftone 2 or an interval between lines can be set arbitrarily.

Lines can be drawn in a direction parallel to a detection deviation direction. In a vertical line pattern for a main scanning detection, the halftone 2 is formed by main scanning direction lines. A pattern 1 positioned on an upper side is formed by a solid image (solid coloring).

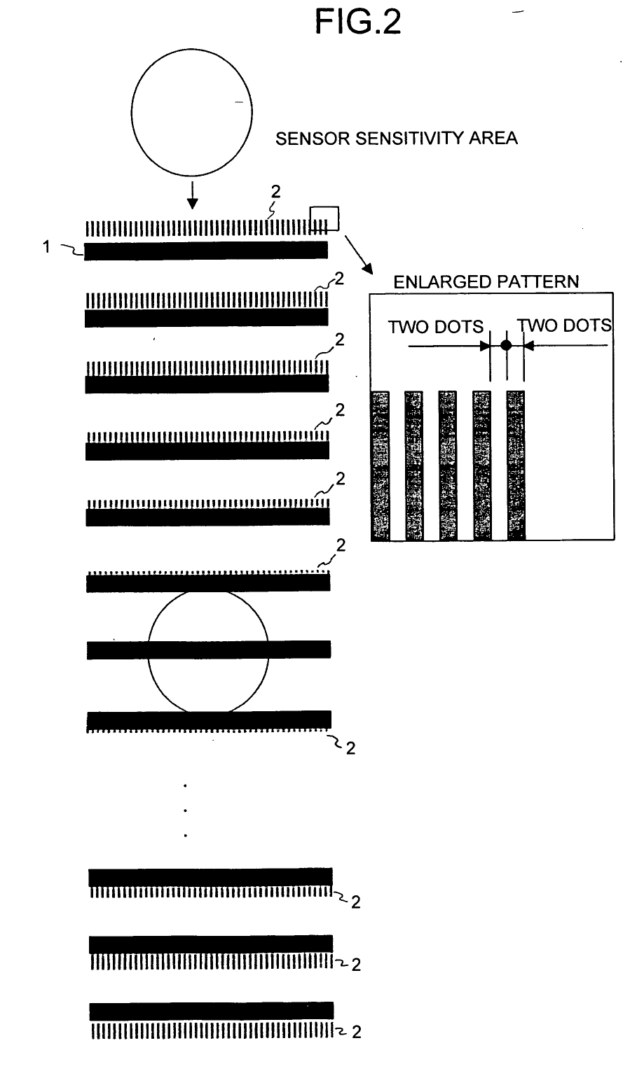

As shown in FIG. 2, a lower pattern of two color patterns to be overlapped is formed by the halftone 2.

The halftone 2 used here is formed by arranging lines with two dot width at intervals of a width of the same line. The width of the line or the interval is simply illustrative, and any line width or interval can be used.

While it is preferable to draw the lines in a direction parallel to a detection deviation direction, they can be drawn in a different direction. In a horizontal line pattern for detection in a sub-scanning direction, the halftone 2 used here is formed by lines extending in a sub-scanning direction. Upper patterns can be formed by a solid image (all the patterns are drawn with a color with the same density).

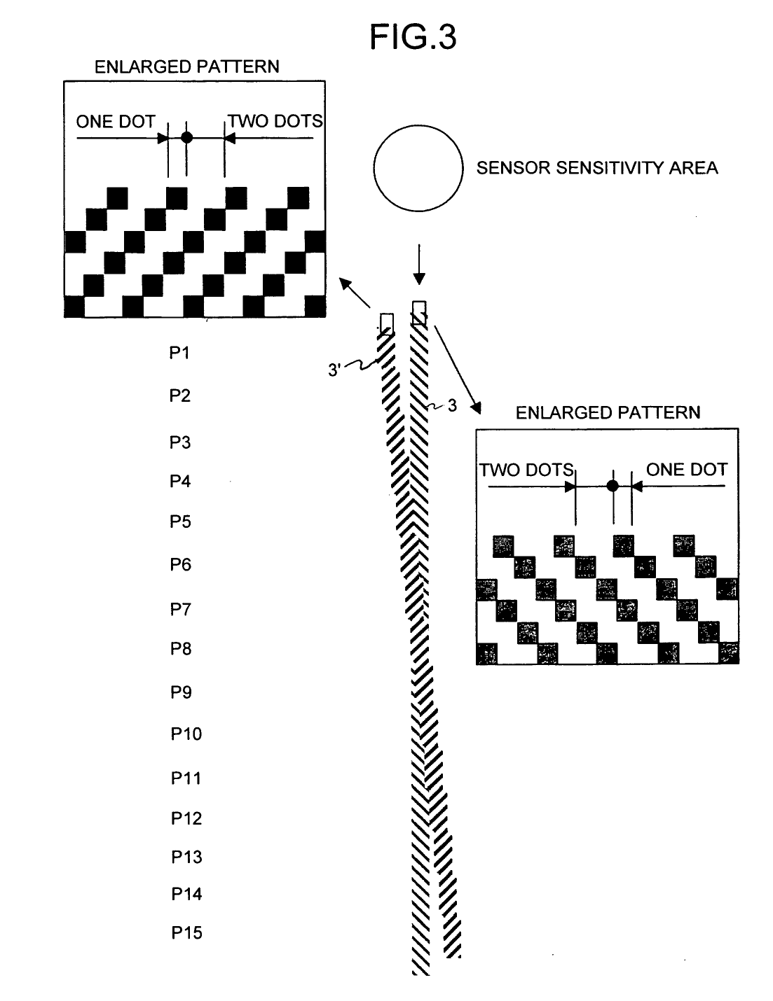

As shown in FIG. 3, two color images to be overlapped with each other can be formed by halftones 3 and 3′.

The halftones 3 and 3′ are formed by drawing two sets of lines obliquely in crossing (symmetrical) directions with two different colors, for example, as shown in FIG. 3.

A line width or an interval for forming the halftones 3 and 3′ is determined arbitrarily like the above. Regarding the oblique angles of the halftones, the halftones 3, and 3′ are required for only arrangement in crossing (symmetrical) directions to each other and they can be set at arbitrary angles.

Since halftones formed symmetrically in this manner are used, a sensor output is hardly affected by density fluctuation.

By detecting the patterns (two overlapping patterns combined) explained above using a sensor, even if an image density fluctuates, fluctuation of a sensor output (output of a sensor signal) is reduced, and linearity of the sensor output to a deviation amount is improved, so that precision and reliability of detection are improved.

Even if two colors are made to overlap with each other, linearity of a detection deviation amount to deviation is not affected by a line interval for setting a density of a halftone. While respective patches are arranged continuously as shown in FIG. 3, they can be arranged at appropriate intervals.

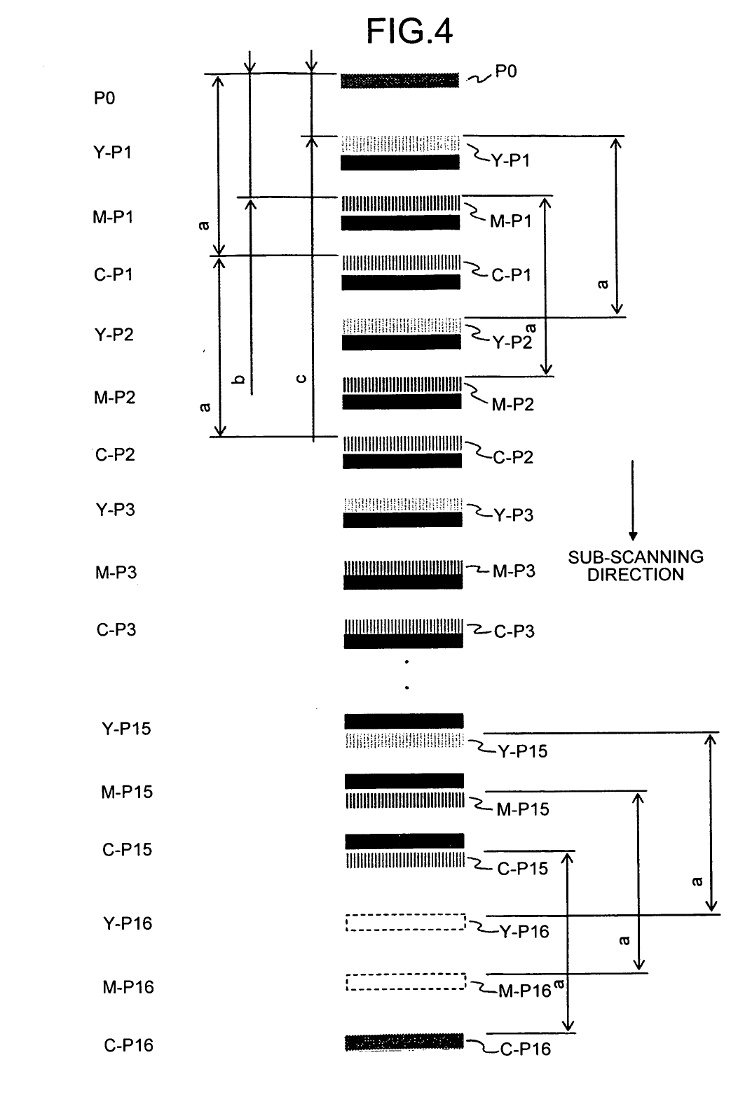

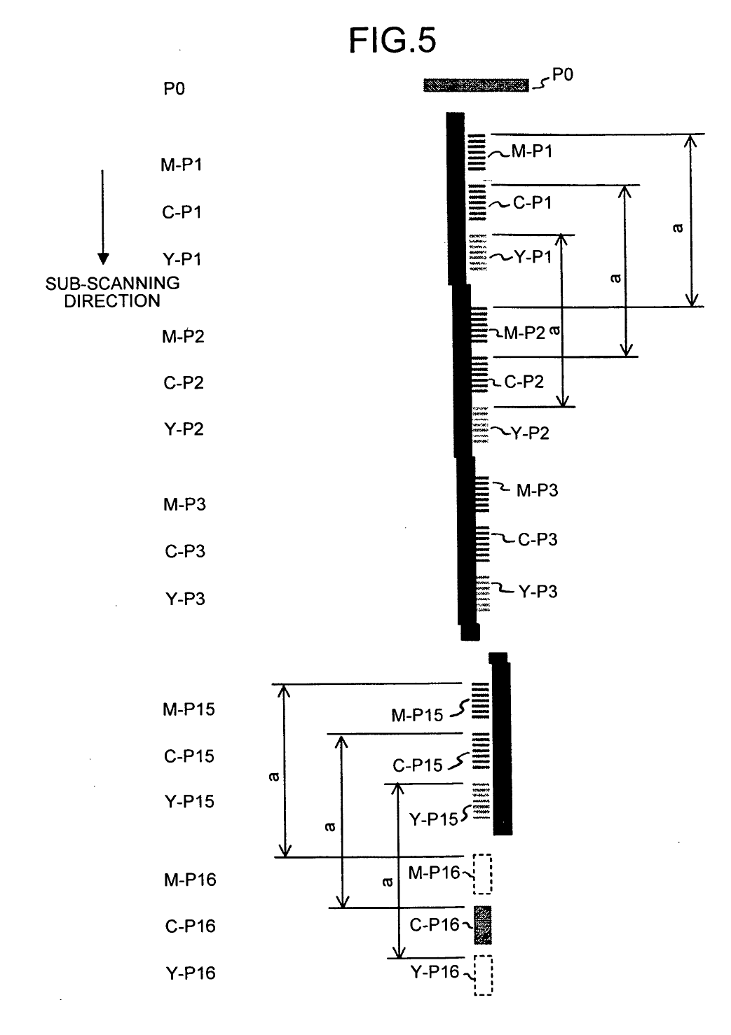

As shown in FIGS. 4 and 5, a pattern for trigger detection PO is arranged at the top of detection patterns or a pattern for confirmation (there are -P16s following Y, M, C in this order in FIG. 4, and there are -P16s following M, C, Y in this order in FIG. 5) is arranged at the end of the detection patterns. The pattern for trigger detection and the pattern for confirmation are arranged at the top and the end of the detection patterns, densities of the halftone patterns in patterns for deviation amount detection (there are -P16s following Y, M, C in this order in FIG. 4, and there are -P16s following M, C, Y in this order in FIG. 5) and densities of the pattern for trigger detection and the pattern for confirmation are compared with each other, and densities of the halftone of the pattern for trigger detection at the top or the halftone of the pattern for confirmation at the end is elevated, so that sensor output levels for trigger detection and reading confirmation are prevented from lowering.

Thereby, even if the halftone is used as a pattern for deviation amount detection, reliability of trigger detection and reliability of reading confirmation are not lowered.

A line width and an interval of at least one of halftones used for forming the patterns can be selected arbitrarily like the above. In FIGS. 4 and 5, a halftone with a higher density of halftones forming patterns can be formed by a solid image.

Thereby, even if fluctuation occurs in an image density, fluctuation of a sensor output is reduced and linearity of the sensor output to a deviation amount is improved, so that precision and reliability are improved. It is possible to perform setting where linearity of the detection deviation amount to deviation is not affected by a line interval for setting a halftone density, even if two colors are made to overlap with each other.

Since both patterns are formed by a halftone, negative influence of the density fluctuation can be further reduced.

Even if the halftone is used for the pattern for deviation amount detection, trigger detection and reading confirmation levels are not lowered.

As shown in FIG. 5, P0 formed by one color instead of two overlapping colors is disposed, and a sensor output of PO is used as a read start trigger. In an example shown in FIG. 5, C is used as P0; however, M or Y is arranged at an interval a like C to be used as PO. Accordingly, a pattern can be generated by a specific program on hardware, for example a simple algorithm, and determination can be made with high reliability.

As shown in FIGS. 4 and 5, patterns for reading confirmation (there are -P16s following Y, M, C in this order in FIG. 4, and there are -P16s following M, C, Y in this order in FIG. 5) are arranged. Arrangement is made in a patch output similar to the pattern for deviation amount detection such that at least one color is a reference color or a non-reference color, and when one of the reference color and the non-reference color is arranged, none of the colors is arranged with regard to other colors.

When levels of patch points are read from a sensor output (an output signal from the sensor) like the level reading of the deviation amount detection, a portion where a pattern is present is determined as 1 and a portion where a pattern is absent is determined as 0 from the levels of the patch points in Y-P16, M-P16, and C-P16 shown in FIG. 4. With this arrangement, when the patch points are read normally, 001 (digital value) can be obtained. A digital value 010 is obtained from levels of the patch points M-P16, C-P16, and Y-P16 shown in FIG. 5. By determining whether the result and a normal value coincide with each other, whether the reading result is normal is determined.

When errors or the like in trigger detection occur, the result does not coincide with the normal value. Accordingly, determination can be easily made by storing a program in hardware to execute the program. Since patterns are generated by algorithm according to the program, determination is made with high reliability.

Accordingly, patterns for trigger detection and for confirmation can be generated according to a simple algorithm that can easily be realized by hardware, and determination with high reliability can be made.

As shown in FIG. 5, respective patches of three colors of C, M, and Y are arranged alternately so that they are arranged over a long distance in view of influence of fluctuation in the main scanning direction. According to an apparatus based on such an arrangement and a method using the apparatus, patch arrangement can be prevented from being made lengthy when three colors are viewed as a whole.

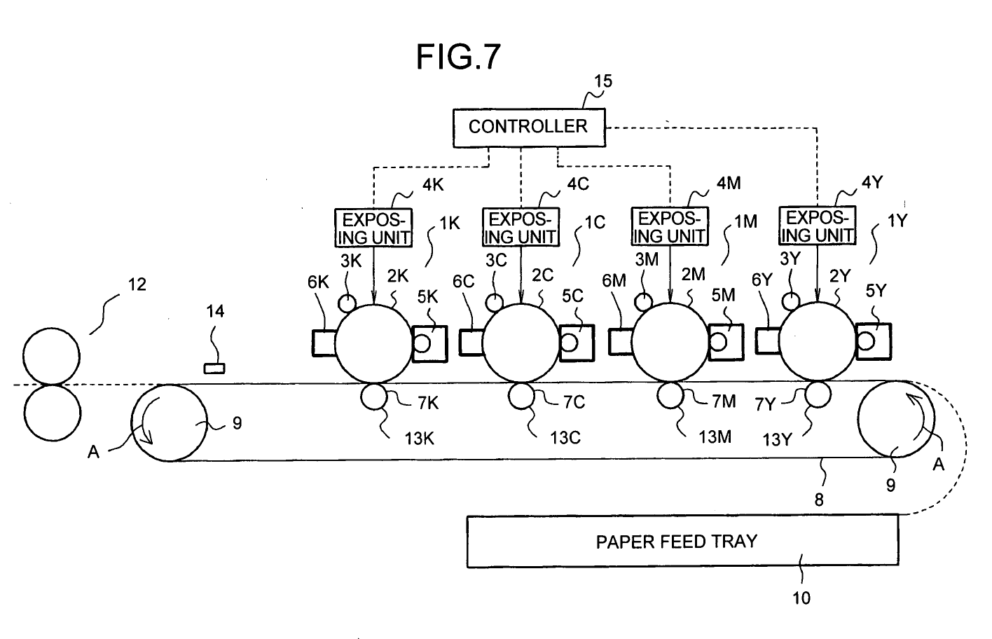

FIG. 7 is a schematic configuration of a color image forming apparatus of a tandem type according to an embodiment of the present invention. In FIG. 7, as described above, four image forming units 1Y, 1M, 1C, and 1K (Y, M, C, and K attached posterior to reference numerals correspond to constituent elements of the respective colors. Symbols representing the colors can be omitted in the following explanations collectively) are arranged along a recording sheet conveying belt 8 (hereinafter, conveying belt) from an upstream side in a rotational direction thereof in the order of the colors.

The respective image forming units 1Y to 1K include photoconductor drums 2Y to 2K functioning as image forming media, and charging units 3Y to 3K, exposing units 4Y to 4K, developing units 5Y to 5K, cleaning units 6Y to 6K, and charge removing units (not shown) arranged around the photosensitive drums. The conveying belt 8 is rotationally driven in a direction of arrow A by rollers 9, one of which is a driving roller.

After surfaces of the photosensitive drums 2Y to 2K are charged evenly by the charging units 3Y to 3K, they are exposed by the exposing units 4Y to 4K by patterns corresponding to images to be outputted, so that latent images are formed on the surfaces of the photosensitive drums 2Y to 2K. The latent images formed on the respective photosensitive drums 2Y to 2K are developed by the developing units 5Y to 5K, so that toner images of respective colors are formed as visible images.

A recording sheet as a recording medium is fed from a paper feed tray to be made to pass through the respective image forming units 1Y to 1K by the conveying belt, where respective toner images formed on the respective photosensitive drums 2Y to 2K are sequentially transferred and superimposed on the same portion of the recording sheet at respective transfer positions of the photosensitive drums 2Y to 2K, so that one color image can be obtained on the recording sheet. The recording sheet transferred with a four color toner image is removed from the conveying (transfer) belt, the four color toner image is fixed on the recording sheet in a fixing device, and the recording sheet is discharged from a paper discharge roller.

After the respective toner images formed on the respective photosensitive drums 2Y to 2K are transferred, residual toners on the photosensitive drums 2Y to 2K are removed by the cleaning units 6Y to 6K,. so that the photosensitive drums 2Y to 2K become ready for the next image forming cycle.

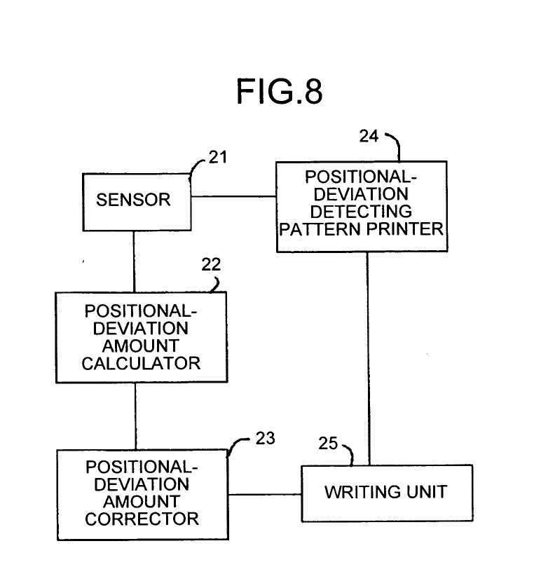

As shown in FIG. 8, such an image forming apparatus at least includes a light receiving sensor 21 that is a position detecting sensor for detecting positional deviation, a positional-deviation amount calculator 22 that is inputted with a value of a pattern density detected by the sensor 21 to calculate a positional deviation amount, a positional-deviation amount corrector 23 that is inputted with the positional deviation amount from the positional-deviation amount calculator 22 to correct the positional deviation amount, a positional-deviation detecting pattern printer 24 for printing a pattern for detecting positional deviation, and a writing unit 25 that writes image information of positional deviation detecting pattern.

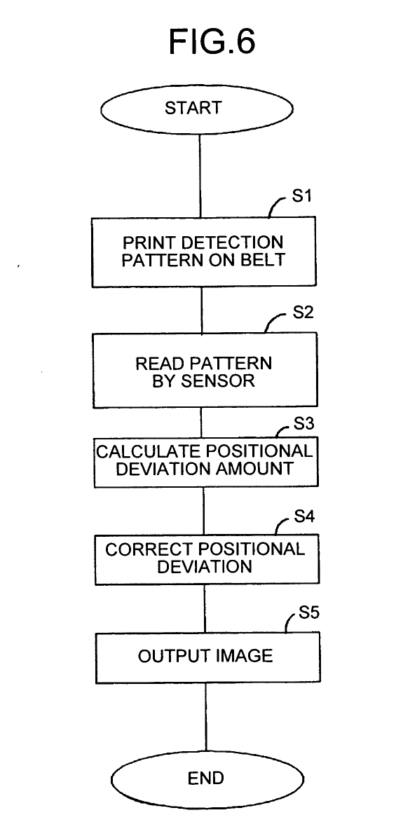

In such an apparatus, as shown in a flowchart of FIG. 6, a detection pattern is printed on the belt (step S1), the pattern is read from the belt by a positional deviation detecting unit (the position detecting sensor, the light receiving sensor) 21 (step S2), and information on the read pattern is signalized to be outputted to a positional deviation amount calculator (for example, a central processing unit.(CPU)) 22. In the positional-deviation amount calculator 22, a positional deviation amount is calculated based on a signal outputted from the positional deviation detecting unit (sensor) 21 to output the same to the positional-deviation amount corrector 23 (step S3).

In the positional-deviation amount corrector 23, an output to the writing unit 25 is performed so as to correct the positional deviation amount based on the positional deviation amount calculated by the positional-deviation amount calculator 22 (step S4). The writing unit 25 performs writing on a printing medium based on the output. The positional-deviation detecting pattern printer 24 outputs a written image (step S5).

Thereby, even if patches are arranged over a long distance in view of influence of fluctuation in the main scanning direction, a patch arrangement is not made so lengthy when three colors are viewed as a whole.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a light receiving unit that irradiates light to patterns including a plurality of colors formed on an image carrier and then transferred onto a transfer member, and receives a light reflected from the patterns, the patterns including an upper layer serving as a reference color with low lightness overlapping a lower layer serving as a non-reference color with high lightness, wherein at least the lower layer is halftone; and
a deviation amount detector that detects a deviation amount of the lower layer relative to the upper layer as a writing positional deviation amount according to density information of the patterns based on the light received by the light receiving unit.

2. The image forming apparatus according to claim 1, wherein
the deviation amount detector detects a deviation amount in a main scanning direction according to density information of patterns,
the upper layer is formed such that a plurality of rectangular shapes whose first sides are parallel to a sub-scanning direction and whose second sides are parallel to the main scanning direction are arranged such that, while the first sides are kept in parallel with the sub-scanning direction, the second sides are arranged so as to be shifted at predetermined intervals in the main scanning direction, and a longitudinal direction of the upper layer extends in non-parallel with the sub-scanning direction as a whole,
the lower layer is formed in a rectangular shape having a long side parallel to the sub-scanning direction, and
the lower layer crosses the upper layer portion.

3. The image forming apparatus according to claim 2, wherein the lower layer is formed by lines parallel to the main scanning direction.

4. The image forming apparatus according to claim 2, wherein the upper layer is formed by a solid image.

5. The image forming apparatus according to claim 2, wherein
the rectangular shapes forming the upper layer portion are halftone including parallel lines having a predetermined angle with respect to the main scanning direction, and
the lower layer is halftone including parallel lines having a predetermined angle to the main scanning direction oppositely of the predetermined angle with respect to the main scanning direction defined by the parallel lines of the upper layer.

6. The image forming apparatus according to claim 2, wherein the lower layer is formed by cyclically arranging rectangular shapes having n or more colors at predetermined intervals in the sub-scanning direction, wherein n is equal to two.

7. The image forming apparatus according to claim 6, wherein n is equal to three.

8. The image forming apparatus according to claim 7, wherein
at least one of the rectangular shapes in a final cycle formed in the sub-scanning direction is formed by any one of the reference color and a non-reference color, and
the rectangular shapes other than the at least one in the final cycle is formed by a solid image of a color other than the reference color and the non-reference color.

9. The image forming apparatus according to claim 2, wherein
the deviation amount detector detects, as a trigger, light received by the light receiving unit at a leading position in the sub-scanning direction of the patterns.

10. The image forming apparatus according to claim 1, wherein
the deviation amount detector detects a deviation amount in a sub-scanning direction according to density information of the patterns,
the upper layer is formed such that a plurality of rectangular shapes whose first sides are parallel to a sub-scanning direction and whose second sides are parallel to the main scanning direction are arranged in a ladder structure in the sub-scanning direction with predetermined intervals therebetween,
the lower layer is formed such that a plurality of rectangular shapes whose third sides are parallel to the sub-scanning direction and whose fourth sides are parallel to the main scanning direction are arranged in a ladder structure in the sub-scanning direction with predetermined intervals therebetween, and
the intervals in the upper layer are different from the intervals in the lower layer.

11. The image forming apparatus according to claim 10, wherein
the deviation amount detector detects a deviation amount in the sub-scanning direction from patterns in which the rectangular shapes in the lower layer are halftone including lines parallel to the sub-scanning direction.

12. The image forming apparatus according to claim 11, wherein
the deviation amount detector detects a deviation amount in the sub-scanning direction according to density information of patterns in which the upper layer is formed by a solid image.

13. The image forming apparatus according to claim 10, wherein the rectangular shapes in the lower layer are formed by cyclically arranging rectangular shapes having n or more colors at predetermined intervals in the sub-scanning direction, wherein n is equal to two.

14. The image forming apparatus according to claim 13, wherein n is equal to three.

15. The image forming apparatus according to claim 1, wherein
at least one trigger pattern for trigger detection at a position ahead of the pattern moving in the sub-scanning direction and a pattern for reading confirmation at a position behind the pattern moving in the sub-scanning direction is formed at a density higher than a density of the halftone constituting the lower layer, and
the deviation amount detector detects at the least one trigger pattern and the pattern for reading confirmation.

16. A method of forming an image in an image forming apparatus including an image carrier and a transfer member, the method comprising:
irradiating light to patterns including a plurality of colors formed on the image carrier and then transferred onto the transfer member, the patterns including an upper layer serving as a reference color with low lightness overlapping a lower layer serving as a non-reference color with high lightness, wherein at least the lower layer is halftone;
receiving a light reflected from the patterns; and
detecting a deviation amount of the lower layer relative to the upper layer as a writing positional deviation amount according to density information of the patterns based on the light received at the receiving.

17. The method according to claim 16, wherein
the detecting includes detecting a deviation amount in a main scanning direction according to density information of patterns,
the upper layer is formed such that a plurality of rectangular shapes whose first sides are parallel to a sub-scanning direction and whose second sides are parallel to the main scanning direction are arranged such that, while the first sides are kept in parallel with the sub-scanning direction, the second sides are arranged so as to be shifted at predetermined intervals in the main scanning direction, and a longitudinal direction of the upper layer extends in non-parallel with the sub-scanning direction as a whole,
the lower layer is formed in a rectangular shape having a long side parallel to the sub-scanning direction, and
the lower layer crosses the upper layer portion.

18. The method according to claim 17, wherein the lower layer is formed by lines parallel to the main scanning direction.

19. The method according to claim 17, wherein the upper layer is formed by a solid image.

20. The method according to claim 17, wherein
the rectangular shapes forming the upper layer portion are halftone including parallel lines having a predetermined angle with respect to the main scanning direction, and
the lower layer is halftone including parallel lines having a predetermined angle to the main scanning direction oppositely of the predetermined angle with respect to the main scanning direction defined by the parallel lines of the upper layer.

21. The method according to claim 17, wherein the lower layer is formed by cyclically arranging rectangular shapes having two or more colors at predetermined intervals in the sub-scanning direction.

22. The method according to claim 21, wherein the rectangular shapes have three or more colors.

23. The method according to claim 22, wherein
at least one of the rectangular shapes in a final cycle formed in the sub-scanning direction is formed by any one of the reference color and a non-reference color, and
the rectangular shapes other than the at least one in the final cycle is formed by a solid image of a color other than the reference color and the non-reference color.

24. The method according to claim 17, wherein
the detecting includes detecting, as a trigger, light received at the receiving at a leading position in the sub-scanning direction of the patterns.

25. The method according to claim 16, wherein
the detecting includes detecting a deviation amount in a sub-scanning direction according to density information of the patterns,
the upper layer is formed such that a plurality of rectangular shapes whose first sides are parallel to a sub-scanning direction and whose second sides are parallel to the main scanning direction are arranged in a ladder structure in the sub-scanning direction with predetermined intervals therebetween,
the lower layer is formed such that a plurality of rectangular shapes whose third sides are parallel to the sub-scanning direction and whose fourth sides are parallel to the main scanning direction are arranged in a ladder structure in the sub-scanning direction with predetermined intervals therebetween, and
the intervals in the upper layer are different from the intervals in the lower layer.

26. The method according to claim 25, wherein
the detecting includes detecting a deviation amount in the sub-scanning direction from patterns in which the rectangular shapes in the lower layer are halftone including lines parallel to the sub-scanning direction.

27. The method according to claim 26, wherein
the detecting includes detecting a deviation amount in the sub-scanning direction according to density information of patterns in which the upper layer is formed by a solid image.

28. The method according to claim 25, wherein the rectangular shapes in the lower layer are formed by cyclically arranging rectangular shapes having two or more colors at predetermined intervals in the sub-scanning direction.

29. The method according to claim 28, wherein the rectangular shapes have three or more colors.

30. The method according to claim 16, wherein
at least one of a trigger pattern for trigger detection at a position ahead of the pattern moving in the sub-scanning direction and a pattern for reading confirmation at a position behind the pattern moving in the sub-scanning direction is formed at a density higher than a density of the halftone constituting the lower layer, and
the detecting includes detecting at least one of the trigger patterns and the pattern for reading confirmation.

31. An image forming apparatus comprising:
a light receiving means for irradiating light to patterns including a plurality of colors formed on an image carrier and then transferred onto a transfer member, and receiving a light reflected from the patterns, the patterns including an upper layer serving as a reference color with low lightness overlapping a lower layer serving as a non-reference color with high lightness, wherein at least the lower layer is halftone; and
a deviation amount detecting means for detecting a deviation amount of the lower layer relative to the upper layer as a writing positional deviation amount according to density information of the patterns based on the light received by the light receiving means.
